(19) United States
(12) Patent Application Publication
(10) Pub. No.: US 2026/0314555 A1
(43) Pub. Date: Oct. 15, 2026

(54) ENVIRONMENT-CONTROLLED PET SHELTER

(71) Applicant: Paws Up Pet Products, LLC, Gainesville, FL (US)

(72) Inventors: Virginia NODHTURFT, Temple Terrace, FL (US); Philip NODHTURFT, III, Gainesville, FL (US); Kevin MORAN, South Lyon, MI (US)

(21) Appl. No.: 19/718,636

(22) Filed: Jun. 24, 2026

Related U.S. Application Data
(63) Continuation-in-part of application No. 19/058,862, filed on Feb. 20, 2025, now Pat. No. 12,690,562.
Application No. 19/058,862 is a continuation-in-part of application No. 17/945,378, filed on Sep. 15, 2022, now abandoned.
(60) Provisional application No. 63/244,308, filed on Sep. 15, 2021.

(51) Int. Cl. A01K 1/00

(52) U.S. Cl. CPC A01K 1/0058

(57) ABSTRACT

An environment-controlled pet shelter includes an outer enclosure and an inner enclosure nested within and mechanically decoupled from the outer enclosure. An air pocket is defined between the enclosures to space them apart. The inner enclosure is supported by a plurality of dome-shaped inner feet that minimize physical contact to reduce structure-borne vibrations. An acoustically baffled ventilation pathway is defined by an air inlet in the outer enclosure and offset ceiling apertures in the inner enclosure, allowing fresh air to circulate while attenuating airborne noise. An active air mover may be positioned within the air pocket to facilitate air circulation, and a resilient collar may be used to further isolate the enclosures. Additionally, a conductive grounding mat may be disposed on the floor of the inner chamber to dissipate static electricity.

### CROSS-REFERENCE TO RELATED APPLICATIONS

This application claims priority pursuant to 35 U.S.C. § 120 and is continuation-in-part of U.S. patent application Ser. No. 19/058,862, filed Feb. 20, 2025, which application is incorporated herein by reference in its entirety.

### FIELD

The present disclosure relates generally to animal shelters, and more particularly to an environment-controlled pet shelter providing acoustic and mechanical isolation for domesticated animals during loud environmental events.

### STATE OF THE ART

Domesticated animals, particularly dogs, possess a highly sensitive auditory range and are frequently subjected to severe anxiety, fear, and physiological stress during loud environmental events such as thunderstorms and fireworks displays. While a young human can typically hear sounds at a threshold of 0 decibels (dB), dogs can generally hear much softer sounds, down to a range between −5 dB and −15 dB on average. Consequently, sounds that are unnoticeable or tolerable to humans can cause extreme discomfort and distress to animals.

Loud environmental events generate noise levels that far exceed safe auditory thresholds. For example, fireworks can emit sounds of up to 190 decibels. This is 110 to 115 decibels above the range of 75 to 80 decibels where damage to the human ear begins, and significantly exceeds the noise levels generated by gunshots (140 decibels) and jet planes (100 decibels).

In addition to high-intensity airborne noise, these environmental events generate high-energy, low-frequency pressure waves and tactile ground-propagated vibrations (structure-borne noise). These tactile vibrations propagate through floors, walls, and ground surfaces directly into the animal's body, compounding their distress and causing secondary physiological symptoms.

One approach to mitigating animal anxiety involves the use of protective enclosures. For example, an animal shelter comprising double-walled panels with internal air pockets and sound-absorbing baffles to attenuate noise. However, passive sound-absorbing panel structures alone may not provide sufficient acoustic attenuation across a wide frequency spectrum, particularly against low-frequency ground vibrations which easily bypass traditional wall panels. Because the walls and floors of such enclosures are rigidly coupled, low-frequency, structure-borne vibrations are transmitted directly from the external floor to the resting animal. Furthermore, maintaining safe and adequate fresh air circulation within highly insulated enclosures remains a significant challenge. Conventional ventilation openings and air passages often serve as direct, unattenuated pathways for sound leakage, creating acoustic bridges that bypass the wall insulation and severely compromise the overall acoustic integrity of the shelter.

There is therefore a long-felt need for an environment-controlled pet shelter that provides integrated multi-domain isolation from both high-intensity airborne noise and low-frequency structure-borne vibrations, while simultaneously maintaining continuous, active ventilation along an acoustically and mechanically isolated pathway.

### SUMMARY

According to an aspect of the present disclosure, an environment-controlled pet shelter is provided that achieves multi-domain environmental, acoustic, and vibrational isolation to alleviate animal anxiety during atmospheric and environmental disturbances. The shelter comprises an outer enclosure and an inner enclosure nested within the outer enclosure to define an inner chamber. An air pocket is defined between the outer and inner enclosures, spacing them apart to establish a continuous acoustic decoupling zone. To support the inner enclosure relative to the outer enclosure while minimizing mechanical contact, a plurality of inner feet extend downward from the inner floor to rest on the outer floor. Fresh air is supplied to the inner chamber through an acoustically baffled pathway defined by an air inlet in the outer walls and a plurality of ceiling apertures in the inner roof that are offset from the air inlet, enabling continuous fluid communication between the exterior and the inner chamber while attenuating high-intensity airborne noise.

In another aspect, an active air mover is positioned within the air pocket adjacent to the inner roof. The active air mover is configured to actively circulate air between the inner chamber, the air pocket, and the exterior of the outer enclosure. This active circulation resolves a critical engineering conflict inherent in highly insulated animal enclosures: the necessity of fresh air delivery to prevent carbon dioxide buildup and heat exhaustion versus the requirement of complete acoustic sealing. By actively drawing air through the offset ceiling apertures and the air pocket, the active air mover forces incoming air—and any accompanying sound waves—along a tortuous, multi-directional path. This path causes the sound waves to undergo multiple reflections and phase cancellations within the air pocket, thereby significantly reducing noise levels within the inner chamber while ensuring a safe, continuous supply of oxygenated air.

In another aspect, the transmission of structure-borne noise and ground-propagated tactile vibrations is mitigated by the geometric configuration of the support interfaces. Each of the plurality of inner feet and outer feet comprises a dome-shaped bottom surface. Traditional flat-bottomed feet maximize physical surface contact, which acts as a highly efficient acoustic coupling bridge that allows low-frequency ground vibrations (such as those caused by thunderclaps, fireworks explosions, or heavy footfalls) to propagate directly into the shelter floor. By utilizing dome-shaped bottom surfaces, the physical contact area at the support interfaces is mathematically restricted to a minimal tangent point-contact. This geometric restriction drastically reduces the vibration transmission coefficient, isolating the inner floor and preventing tactile vibrations from reaching and distressing the resting animal.

In another aspect, a resilient collar comprising a foam material is disposed between an outer surface of the inner enclosure and an inner surface of the outer enclosure. This collar acts as an energy-absorbing mechanical buffer that prevents rigid-body contact between the nested enclosures. When an animal enters the inner chamber, its weight shifts the inner floor relative to the outer floor. Without a dampening buffer, such shifts can cause the inner enclosure to tilt and make direct, rigid contact with the outer walls, creating an accidental vibration bridge. The resilient foam collar absorbs these compressive and shear forces, ensuring the inner enclosure remains floating within the outer enclosure while simultaneously sealing any structural interfaces to prevent airborne sound leakage.

In another aspect, the pet shelter addresses the physiological discomfort caused by static electricity buildup during atmospheric disturbances. A conductive grounding mat is disposed on the inner floor of the inner chamber. During thunderstorms, high static electricity in the atmosphere induces an electrical charge that collects under the dander and fur of the pet, resulting in painful static micro-shocks that trigger severe panic and flight responses. The conductive grounding mat provides a continuous static-dissipation pathway that safely discharges these electrical accumulations to an external ground, eliminating the physical discomfort that contributes to thunderstorm phobia.

In another aspect, the pet shelter includes a door pivotally coupled to the outer enclosure, wherein the door features an inward-projecting sealing portion. This sealing portion is configured to directly interface with the inner enclosure to seal the inner chamber when the door is closed. Standard door frames present significant gaps that allow high-frequency noise to leak into the interior. The inward-projecting sealing portion bridges the gap across the air pocket, directly compressing against the inner enclosure opening to form an acoustic gasket that maintains the continuity of the sound-attenuating barrier.

These and other objects, features, and advantages of the various aspects and embodiments of the present disclosure will become readily apparent upon a review of the following detailed description of the present disclosure, in view of the drawings and appended claims.

### BRIEF DESCRIPTION

The present disclosure can be better understood with reference to the following drawings and description. The components in the figures are not necessarily to scale, emphasis instead being placed upon illustrating the principles of the present disclosure, in which:

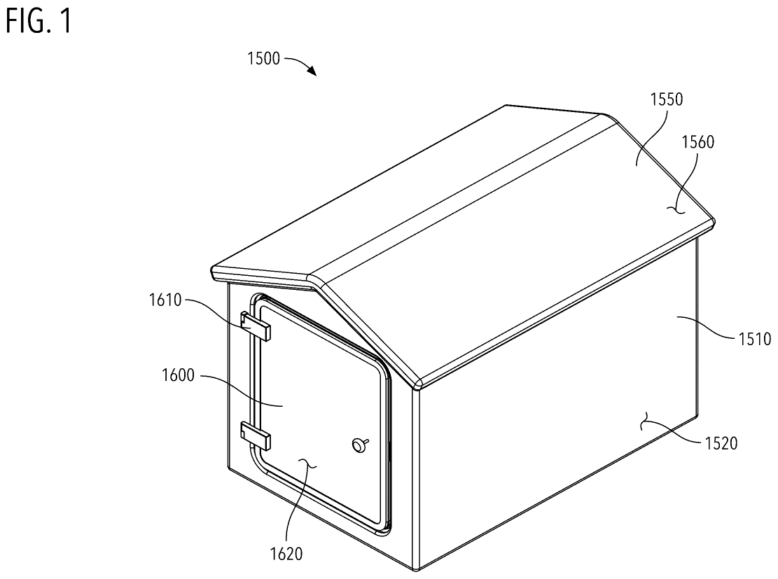

FIG. 1 is a perspective view of a pet shelter of an alternative embodiment, illustrating a box-like outer configuration and a hinged front door;

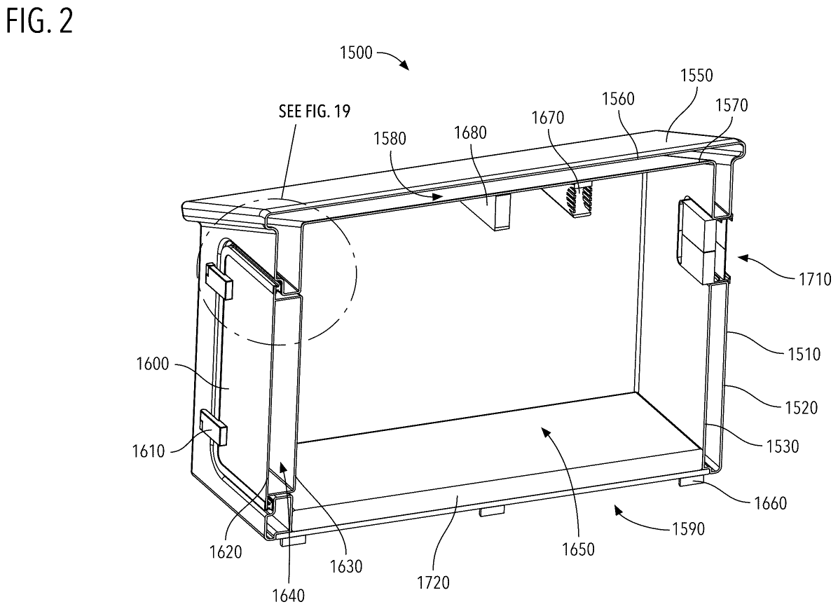

FIG. 2 is a partial cutaway view along the length of the pet shelter of FIG. 1, illustrating a single-enclosure interior chamber and a passive ventilation opening;

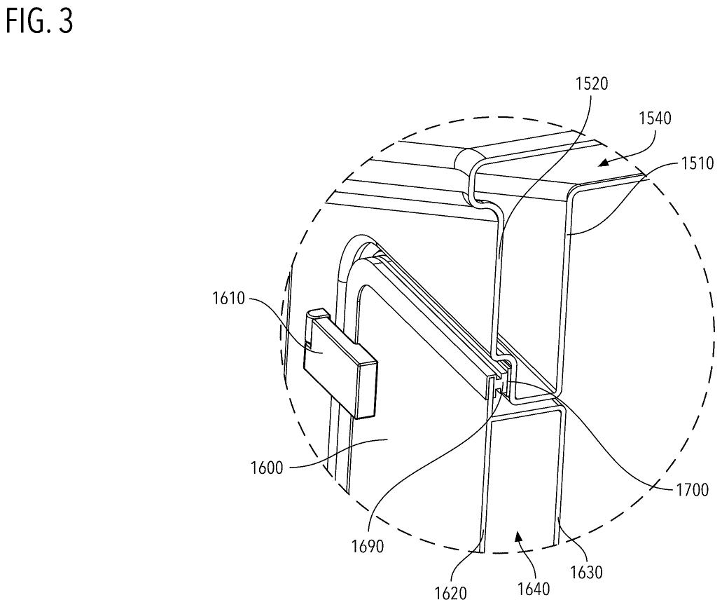

FIG. 3 is a detailed cross-sectional view of the door seal interface of the pet shelter of FIG. 1, illustrating a single-enclosure sealing arrangement;

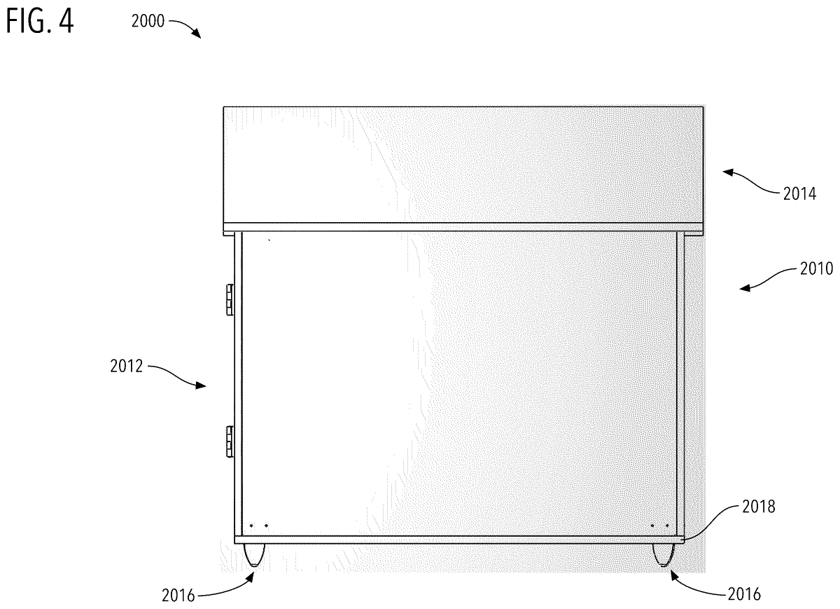

FIG. 4 is a side elevation view of an environment-controlled pet shelter showing an outer enclosure, an outer roof, a front door, and a plurality of outer feet, in accordance with an embodiment of the present disclosure;

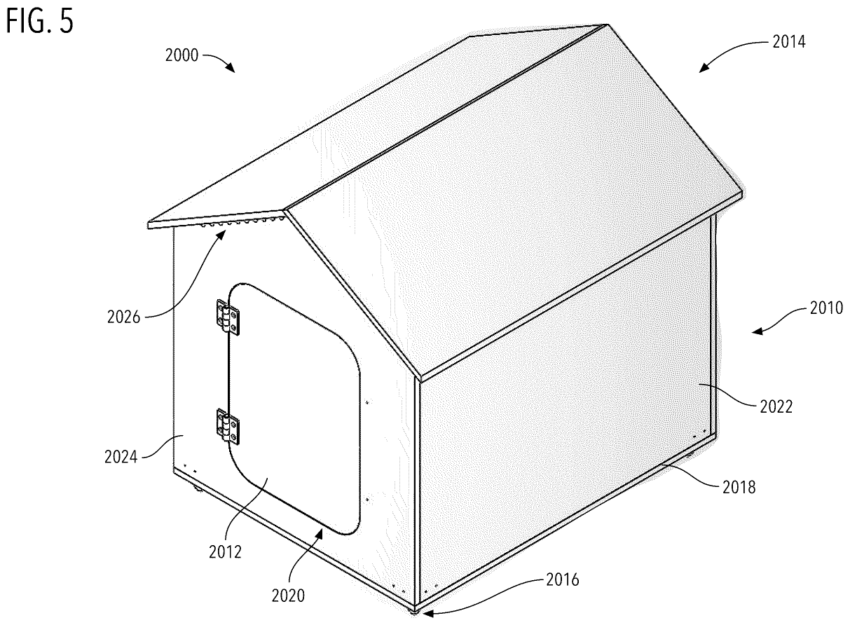

FIG. 5 is an isometric perspective view of the environment-controlled pet shelter of FIG. 4, showing a door opening and a plurality of outer air apertures formed through an outer wall, in accordance with an embodiment of the present disclosure;

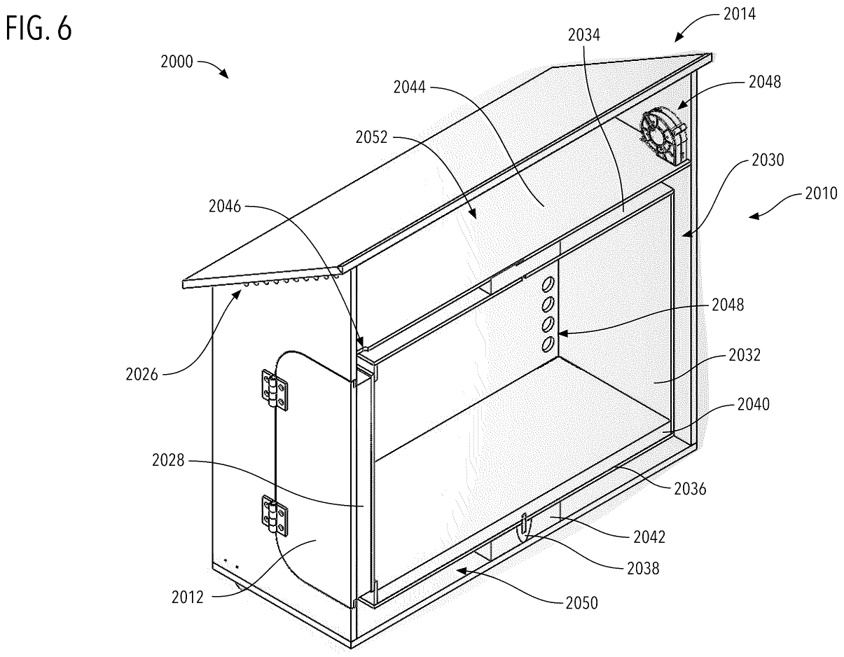

FIG. 6 is an internal perspective cutaway view of the environment-controlled pet shelter of FIG. 4, illustrating a nested inner enclosure, an active air mover, a conductive grounding mat, and a resilient collar positioned within an air pocket, in accordance with an embodiment of the present disclosure;

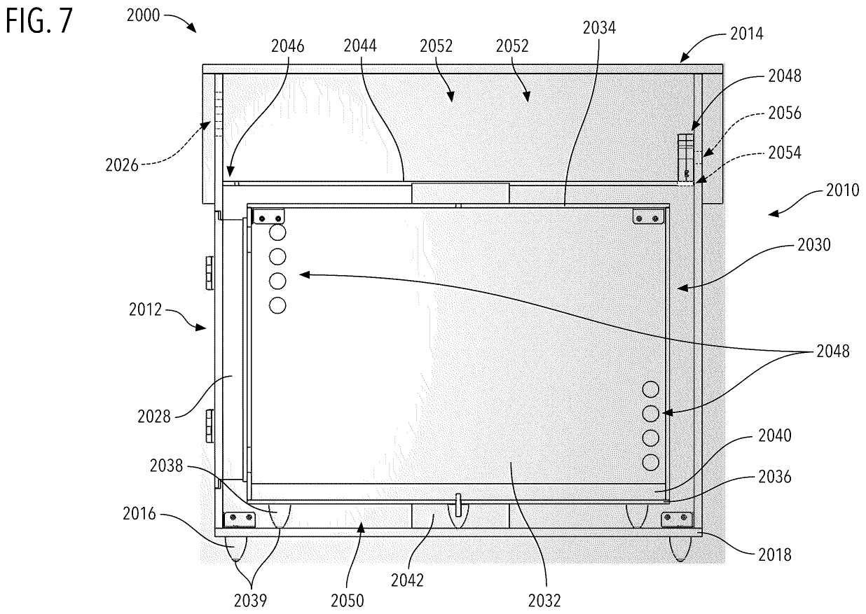

FIG. 7 is a longitudinal cross-sectional view of the environment-controlled pet shelter of FIG. 4, illustrating the active air mover, the air pocket, and a plurality of offset ceiling apertures defining an acoustically baffled active ventilation pathway, in accordance with an embodiment of the present disclosure; and,

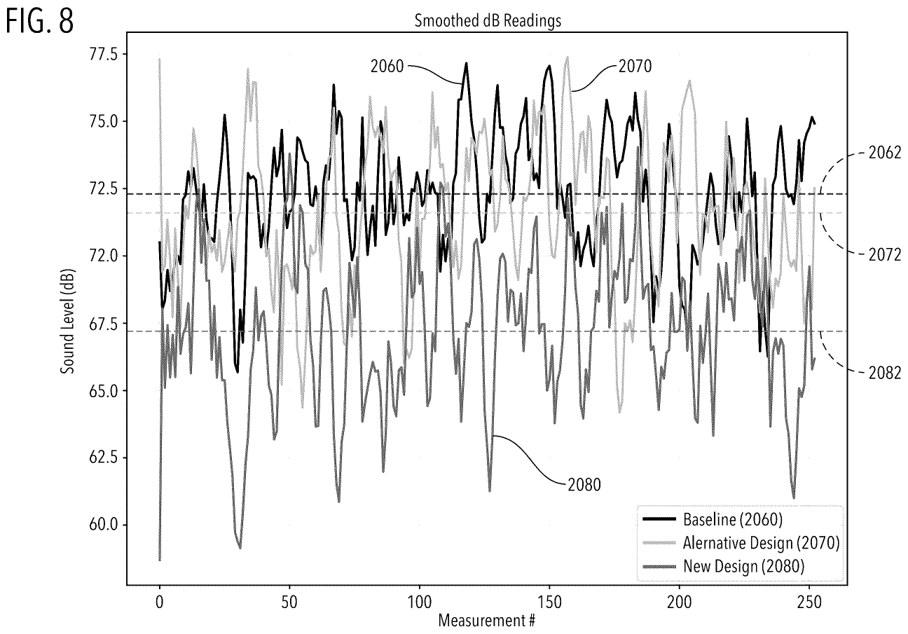

FIG. 8 is a graphical chart illustrating smoothed decibel readings over a series of measurements, comparing the acoustic dampening performance of the environment-controlled pet shelter of the present disclosure against the pet shelter of FIG. 1 and a baseline environment.

### DETAILED DESCRIPTION

Detailed illustrative embodiments of the present disclosure are disclosed herein. However, specific structural and functional details disclosed herein are merely representative for purposes of describing exemplary embodiments. The present disclosure may be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items. Like reference numerals identify similar or identical elements across the different drawings and views.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. The use of permissive or optional language, such as “may,” “can,” “could,” “should,” “might,” or “exemplary,” is used herein to indicate optional, non-required features, configurations, or steps. The absence of such language does not imply that a feature is mandatory, and the disclosure contemplates embodiments both with and without any described optional features.

For purposes of the present disclosure, relative terms such as “substantially,” “generally,” “nominally,” and “approximately” are used to denote reasonable technical variations, manufacturing tolerances, material variations, or standard deviations. The term “substantially” as used in connection with a geometric or structural relationship encompasses standard manufacturing and assembly tolerances. The term “approximately” as used in connection with a numerical value, range, or measurement is defined as encompassing variations within 10% of the stated value, unless the context or technical application dictates a narrower tolerance. The logical connector “or” is used in its non-exclusive sense, such that “A or B” encompasses A alone, B alone, or both A and B together, unless expressly stated otherwise.

To provide explicit written support for potential claim amendments, the transitional phrases used herein are defined in a layered and adaptable manner. The term “comprising” and its variations (e.g., “comprises,” “comprise”) are used as open-ended terms meaning “including, but not limited to,” and do not exclude additional, unrecited elements or method steps. The present disclosure also expressly contemplates narrower embodiments that “consist essentially of” or “consist of” the recited elements, components, or steps.

Any specific dimensions, values, distances, angles, temperatures, pressures, decibel levels, or frequency ranges mentioned herein are merely exemplary and are provided to illustrate a representative embodiment. The present disclosure fully contemplates that these values may be scaled, adjusted, or substituted with any other suitable values, including conversions between imperial and metric units, or adapted to different ranges appropriate for the specific size, weight, and species of animal or target application without departing from the scope of the disclosure.

Any materials specifically identified herein, such as polymeric materials, foam, polyurethane, polyethylene, mass loaded vinyl, elastomeric materials, or composites, are merely exemplary. The structural components of the present disclosure may be formed from any other suitable materials, including but not limited to metals (e.g., aluminum, steel), alloys, natural or synthetic wood, structural plastics, carbon fiber composites, fiberglass, natural or synthetic rubbers, or combinations thereof. Furthermore, the components may be manufactured using any suitable manufacturing methods, including but not limited to injection molding, blow molding, thermoforming, CNC machining, 3D printing, additive manufacturing, extrusion, lamination, die-cutting, or casting.

While the primary use case of the environment-controlled shelter is described herein as a protective pet or domesticated animal enclosure to mitigate anxiety during thunderstorms or fireworks, this application is merely exemplary. The disclosure contemplates other potential applications and fields of use, including but not limited to portable acoustic testing booths, equipment isolation chambers, shipping containers for vibration-sensitive electronics or scientific instruments, general acoustic shielding enclosures, protective transport carriers, or localized quiet zones in industrial and residential environments.

To ensure proper electronic, power, and data-routing support, terms such as “electrically coupled,” “electrically conductive,” and “grounding path” are defined broadly. An electrical coupling or path may be established via direct physical contact, conductive wiring, conductive adhesives, capacitive coupling, inductive coupling, or any other interface that permits the flow of electrical charges, electrons, or static electricity. “Electrically conductive” components encompass materials with low electrical resistance, such as metals, carbon-loaded polymers, conductive foils, or conductive foams, configured to facilitate static dissipation. Static dissipation or grounding paths described herein may interface with any external ground, including standard building wall outlets, surge protectors, ground rods, or dedicated earthing systems, to safely discharge static accumulations.

For the purposes of fluid dynamics and ventilation, the term “fluid communication” is defined as any boundary, pathway, or interface that permits the flow of a fluid, such as air, gases, or vapors, between two or more regions. Fluid communication may be established via an unobstructed opening, a porous material, a mesh screen, or a tortuous, baffled, or multi-directional pathway. A baffled pathway in fluid communication permits the transfer of air or gas while simultaneously presenting a physical barrier that reflects, diffracts, or attenuates sound waves or physical debris passing along the pathway.

Adverting now to the figures, FIG. 1 shows an alternative animal enclosure, which may be a kennel, a crate, or a protective sanctum, e.g., animal shelter 1500. Animal shelter 1500 comprises an outer casing, which may be a shell, a housing, or a perimeter wall, e.g., outer wall 1510. Animal shelter 1500 further comprises a base member, which may be a floor, a platform, or a bottom plate, e.g., bottom panel 1520. Animal shelter 1500 is covered by a covering member, which may be a roof, a lid, or a canopy, e.g., top panel 1550 and top panel 1560. To allow ingress and egress of an animal, animal shelter 1500 comprises an access barrier, which may be a gate, a hatch, or a portal, e.g., door 1600. Door 1600 is pivotally coupled to outer wall 1510 via a pivot mechanism, which may be a pin joint, a strap, or a bracket, e.g., hinge 1610. Door 1600 comprises a viewing window, which may be a transparent pane, a mesh, or a solid sheet, e.g., door panel 1620.

With reference to FIG. 2, animal shelter 1500 defines an interior volume, which may be a cavity, a room, or a resting space, e.g., inner chamber 1650. Animal shelter 1500 is supported on a ground surface by a plurality of support structures, which may be pads, blocks, or stands, e.g., vibration damping feet 1660. To regulate airflow within inner chamber 1650, animal shelter 1500 comprises a circulation device, which may be a blower, an impeller, or a ventilator, e.g., fan 1670. To introduce calming sounds or cancel noise, animal shelter 1500 comprises an audio transducer, which may be a transducer, a buzzer, or a horn, e.g., speaker 1680. To direct air and block sound, animal shelter 1500 comprises a flow redirector, which may be a plate, a louvre, or a deflector, e.g., baffle 1710. To address static charge, animal shelter 1500 comprises a conductive surface, which may be a sheet, a plate, or a mesh, e.g., grounding mat 1720. Door 1600 comprises a latching system, which may be a lock, a bolt, or a catch, e.g., latch 1630, and is received within a frame structure, which may be a border, a casing, or a molding, e.g., door frame 1640. To provide a seal, door 1600 comprises a sealing member, which may be an o-ring, a strip, or a bead, e.g., gasket 1700.

As shown in FIG. 3, door frame 1630 comprises a projecting lip, which may be a rib, a collar, or an extension, e.g., flange 1540. Gasket 1700 is positioned adjacent to a secondary sealing member, which may be a flap, a wiper, or a cord, e.g., gasket 1690. Door frame 1640 interfaces with outer wall 1510 and bottom panel 1520 to secure door 1600. When door 1600 is in a closed position, gasket 1700 and gasket 1690 compress against door frame 1630 and flange 1540 to seal inner chamber 1650.

While the embodiment of FIGS. 1-3 provides a functional enclosure, it relies primarily on a single-enclosure architecture that may be susceptible to low-frequency structure-borne vibrations and acoustic leakage through direct, unbaffled ventilation paths. To address these limitations and provide enhanced acoustic and mechanical isolation, the present disclosure introduces a nested, floating-chamber isolation system.

In FIGS. 4-8, the embodiments shown and described herein relate to an environment-controlled pet shelter that includes an outer enclosure and an inner enclosure nested within and mechanically decoupled from the outer enclosure, i.e., a nested, floating-chamber isolation system. An air pocket is defined between the two enclosures to space them apart and act as an acoustic decoupling zone. To minimize the transmission of structure-borne vibrations, the inner enclosure and the outer enclosure are supported by a plurality of inner feet, which may feature dome-shaped bottom surfaces to restrict physical contact area. An acoustically baffled ventilation pathway is defined by an air inlet in the outer enclosure and a plurality of ceiling apertures in the inner enclosure that are offset from the air inlet, allowing fresh air to circulate between the inner chamber and the exterior while attenuating high-intensity airborne noise. An active air mover may be positioned within the air pocket to facilitate air circulation, and a resilient collar may be sandwiched between the enclosures to further isolate mechanical shifts. Additionally, a conductive grounding mat may be disposed on the floor of the inner chamber to dissipate static electricity.

Referring to FIG. 4, an environment-controlled pet shelter, which may be a kennel, an acoustic isolation crate, or a stress-relief enclosure, e.g., animal shelter 2000, is illustrated. Animal shelter 2000 comprises an outer protective housing, which may be a shell, a casing, or an external frame, e.g., outer enclosure 2010. Outer enclosure 2010 is covered by an external canopy, which may be a roof, a lid, or an upper panel, e.g., outer roof 2014. To facilitate entry and exit, animal shelter 2000 includes an access barrier, which may be a gate, a hatch, or a pivotable panel, e.g., door 2012. Outer enclosure 2010 is supported on an external surface by a plurality of external support members, which may be pads, blocks, or stands, e.g., outer feet 2016.

In reference to FIG. 5, outer enclosure 2010 comprises a base member, which may be a bottom plate, a platform, or a floor panel, e.g., outer floor member 2018. Outer enclosure 2010 further comprises a front wall panel, which may be a door frame wall, a facade, or a front plate, e.g., door wall member 2024, and a side wall panel, which may be a flank, a lateral plate, or a side board, e.g., outer wall member 2022. Door wall member 2024 defines a door-receiving opening, which may be a portal, an entryway, or a hatchway, e.g., door opening 2020, configured to receive door 2012. To permit initial air entry into outer enclosure 2010, door wall member 2024 comprises a plurality of external air inlets, which may be vents, slots, or perforations, e.g., air apertures 2026.

Referring to FIG. 6 and FIG. 7, animal shelter 2000 features a nested inner housing, which may be an inner shell, an isolated chamber, or an inner box, e.g., inner enclosure 2030, positioned entirely within outer enclosure 2010. Inner enclosure 2030 defines an inner chamber, which may be a pet resting area, a quiet zone, or an isolated room, e.g., inner chamber 2031. Inner enclosure 2030 comprises a plurality of inner wall panels, which may be inner planks, sheets, or linings, e.g., inner wall member 2032. Inner enclosure 2030 further comprises an inner ceiling panel, which may be an inner roof, a top plate, or a ceiling board, e.g., inner roof member 2034, and an inner base panel, which may be an inner floor, a bottom tray, or a base board, e.g., inner floor member 2036.

To isolate inner enclosure 2030 from outer enclosure 2010, an acoustic decoupling zone, which may be an insulation cavity, a spacing, or a gap, e.g., air pocket 2050 and air pocket 2052, is defined between the outer and inner enclosures. Air pocket 2050 is defined between outer wall member 2022 and inner wall member 2032, while air pocket 2052 is defined between outer roof 2014 and inner roof member 2034.

Inner enclosure 2030 is supported relative to outer floor member 2018 by a plurality of internal support elements, which may be columns, dowels, or spacers, e.g., inner feet 2038. Inner feet 2038 extend downward from inner floor member 2036 and rest on the upper surface of outer floor member 2018. To minimize structure-borne vibration transfer, each inner foot 2038 comprises a rounded bottom surface, which may be a dome, a hemisphere, or a convex tip, e.g., dome-shaped bottom surface 2039. Dome-shaped bottom surface 2039 restricts the contact area between inner foot 2038 and outer floor member 2018 to a minimal tangent point-contact, drastically reducing the transmission coefficient of low-frequency vibrations. Similarly, each outer foot 2016 comprises a dome-shaped bottom surface to minimize contact with an external support surface. It should be noted that “dome-shaped” is also intended to mean a tipped or pointed distal end of each of the inner feet and the outer feet to further a minimal tangent point-contact.

To dissipate static electricity, animal shelter 2000 comprises a static-dissipative mat or sheet, which may be a conductive plate, a carbon-loaded mat, or a metal mesh, e.g., grounding mat 2040, disposed on inner floor member 2036. In some embodiments, at least one inner foot 2038 is conductive and electrically coupled to grounding mat 2040.

To achieve multi-stage decoupling and environmental control, animal shelter 2000 comprises a resilient damping member, which may be a rubber gasket, an elastomeric ring, or a foam buffer, e.g., collar 2042, disposed between an outer surface of inner enclosure 2030 and an inner surface of outer enclosure 2010. Collar 2042 may comprise a resilient foam material, preferably open-cell, and is primarily configured to mechanically decouple inner enclosure 2030 from outer enclosure 2010. Additionally, collar 2042 is configured to provide an air buffer within air pocket 2050, bifurcating air pocket 2050 into a front portion and a back portion to direct airflow and assist in proper air circulation and ventilation. Furthermore, collar 2042 could be configured to provide an interface or routing path for an external ground to safely pass through and connect with grounding mat 2040. Since collar 2042 is preferably designed to be wrapped around inner enclosure 2030 and effectively sandwiched between respective inner surfaces of outer enclosure 2010, its inclusion can eliminate the need for the plurality of inner feet 2038.

To actively circulate air, animal shelter 2000 comprises an active air circulation device, which may be a fan, a blower, or an impeller, e.g., fan 2048. Fan 2048 is positioned within air pocket 2052 adjacent to inner roof member 2034. Inner roof member 2034 comprises a plurality of air-routing holes, which may be ceiling perforations, inlet slots, or vents, e.g., ceiling apertures 2046 and inlet apertures 2054. Ceiling apertures 2046 and inlet apertures 2054 are offset from air apertures 2026. This offset arrangement defines an acoustically baffled pathway. Fan 2048 draws fresh air from outside outer enclosure 2010 through air apertures 2026, into air pocket 2052, and forces it through inlet apertures 2054 and ceiling apertures 2046 into inner chamber 2031. Because the air path is tortuous and multi-directional, airborne sound waves entering air apertures 2026 undergo multiple reflections and phase cancellations within air pocket 2052, attenuating high-frequency noise before the air enters inner chamber 2031.

Door 2012 comprises an inward-extending sealing structure, which may be an acoustic plug, a gasketed protrusion, or a door collar, e.g., sealing portion of door 2028. When door 2012 is in a closed position, sealing portion of door 2028 extends through door opening 2020 and interfaces directly with inner enclosure 2030 to seal inner chamber 2031, preventing sound waves from leaking into the air pocket around the door frame.

FIG. 8 shows a performance comparison chart for acoustic tests and illustrates empirical validation of the acoustic isolation performance of animal shelter 2000.

Under a system volume of 70 at a distance of 9 feet, a baseline curve, which may be a raw acoustic signature, a reference plot, or an unsheltered sound level line, e.g., baseline curve 2060 (shown as a solid black line), represents the ambient noise of the external environment. A baseline average line, which may be a mean threshold, a center line, or a steady-state reference, e.g., baseline average line 2062, shows an average sound level of 72.3 dB.

An alternative design curve, which may be a single-enclosure signature, a prior design plot, or a non-decoupled benchmark, e.g., alternative design curve 2070, represents the acoustic performance of the alternative single-enclosure design of FIG. 1. An alternative average line, which may be an alternative mean threshold, a prior average line, or a single-shell center line, e.g., alternative average line 2072, shows a minimal sound reduction of only 0.7 dB, averaging 71.6 dB.

In contrast, a new design curve, which may be a nested-enclosure signature, a decoupled-chamber plot, or an isolated system line, e.g., new design curve 2080, represents the acoustic performance of the nested, floating-chamber design of animal shelter 2000. A new average line, which may be a decoupled mean threshold, a floating-chamber center line, or an isolated average line, e.g., new average line 2082, shows a dramatic average sound level of 67.2 dB.

This represents a sound level reduction of 5.1 dB compared to baseline average line 2062 (a 69% reduction in perceived sound intensity, rendering the interior of inner chamber 2031 approximately half as loud) and a 4.4 dB reduction compared to alternative average line 2072 (a 64% reduction in perceived sound intensity). This demonstrates the highly synergistic effect of combining nested air pocket 2050, 2052, dome-shaped bottom surface 2039 of inner feet 2038 and outer feet 2016, resilient collar 2042, and the offset active ventilation pathway defined by ceiling apertures 2046 and inlet apertures 2054.

In view of the structural, mechanical, and acoustic relationships illustrated across FIGS. 4-8, the environment-controlled pet shelter provides a highly integrated, multi-domain isolation system that cooperatively mitigates both airborne and structure-borne disturbances. The physical cooperation of the individual components described in FIGS. 4-7 directly results in the superior acoustic performance and decibel reduction demonstrated in FIG. 8.

As shown in FIGS. 4, 5, 6, and 7, the nested relationship between outer enclosure 2010 and inner enclosure 2030 establishes a complete structural barrier. Rather than relying on simple insulated panels, the present disclosure utilizes continuous air pocket 2050, 2052 to physically decouple the entire perimeter of the pet's resting environment from the external environment. This floating-chamber architecture is mechanically supported by inner feet 2038 (FIGS. 6, 7) and outer feet 2016 (FIGS. 4, 5). By employing dome-shaped bottom surface 2039 on each of inner feet 2038 and outer feet 2016, the mechanical transmission path for ground-propagated vibrations is geometrically restricted to a minimal tangent point-contact. This point-contact interface acts as a high-impedance boundary that reflects and attenuates low-frequency mechanical energy before it can vibrate inner floor member 2036.

Simultaneously, the active ventilation system shown in FIGS. 5, 6, and 7 resolves the historical trade-off between fresh air delivery and acoustic sealing. By positioning fan 2048 within air pocket 2052 adjacent to inner roof member 2034, air is actively circulated between the exterior, air pocket 2052, and inner chamber 2031. Because ceiling apertures 2046 and inlet apertures 2054 are spatially offset from outer air apertures 2026, incoming air is forced through a tortuous, multi-directional path. This path acts as an acoustic baffle, forcing high-frequency sound waves to undergo multiple reflections, phase cancellations, and absorption cycles within air pocket 2052, thereby neutralizing noise before it can enter inner chamber 2031.

This acoustic and mechanical isolation is further reinforced by the sealing and damping interfaces. As illustrated in FIGS. 6 and 7, sealing portion of door 2028 projects inward from door 2012 through door opening 2020 to directly compress against and seal the opening of inner enclosure 2030. This ensures that the acoustic integrity of inner chamber 2031 is maintained at the primary access point. Furthermore, collar 2042 (FIGS. 6, 7) is sandwiched between the outer surface of inner enclosure 2030 and the inner surface of outer enclosure 2010. Collar 2042 acts as an energy-absorbing damping buffer that prevents accidental rigid-body contact between the enclosures during animal movement, while also bifurcating air pocket 2050 to optimize the active air circulation pathway. For additional physiological relief, grounding mat 2040 (FIGS. 6, 7) could be electrically coupled to at least one conductive inner foot 2038 and the grounding mat to establish a static-dissipation pathway that discharges anxious static charges to an external ground.

The real-world efficacy of this synergistic structural cooperation is mathematically and experimentally validated by the performance comparison chart of FIG. 8. As shown by new design curve 2080 and new average line 2082, the nested, decoupled, and actively ventilated architecture of animal shelter 2000 achieves a dramatic acoustic reduction, maintaining an average internal sound level of 67.2 dB in an environment with a baseline average line 2062 of 72.3 dB. This represents a 5.1 dB reduction compared to baseline curve 2060 (a 69% reduction in perceived sound intensity) and a 4.4 dB reduction compared to alternative average line 2072 of the alternative single-enclosure embodiment of FIGS. 1-3 (a 64% reduction in perceived sound intensity). Accordingly, the structural and functional cooperation of the elements shown in FIGS. 4-7 provides a quiet, vibration-free, and static-free sanctuary that effectively mitigates pet stress and anxiety during severe environmental events.

Furthermore, any of the structural components, features, or accessories described in connection with the alternative embodiment of FIGS. 1-3 may be selectively integrated into the environment-controlled pet shelter 2000 of FIGS. 4-8. For example, an audio transducer, which may be a speaker, a buzzer, or a sound generator, e.g., speaker 1680, may be disposed within inner chamber 2031 of inner enclosure 2030 to play calming sounds, white noise, or active noise-cancellation signals to further complement the passive acoustic isolation of air pocket 2050, 2052. Additionally, a viewing window, which may be a transparent pane, a mesh screen, or a solid sheet, e.g., door panel 1620, may be integrated into door 2012 to allow visual monitoring of a pet within inner chamber 2031 without compromising the structural integrity of door 2012. To secure door 2012 in the closed position, a latching system, which may be a lock, a bolt, or a catch, e.g., latch 1630, may be mounted on door 2012 and configured to selectively engage outer enclosure 2010. Furthermore, one or more additional sealing members, which may be o-rings, rubber strips, or flexible beads, e.g., gasket 1690 or gasket 1700, may be positioned circumferentially around sealing portion of door 2028 or door opening 2020 to provide multiple redundant sealing interfaces that enhance both the acoustic seal and environmental control of inner chamber 2031.

### EXAMPLES

The following provides a detailed description of certain exemplary embodiments of the present disclosure. It is to be understood that these embodiments are provided for illustrative purposes and are not to be construed as limiting the scope of the disclosure in any way.

In some aspects, an environment-controlled pet shelter is configured as a nested, multi-enclosure isolation system comprising an outer enclosure and an inner enclosure nested entirely within the outer enclosure. The outer enclosure may comprise an outer floor, a plurality of outer walls, and an outer roof, while the inner enclosure may comprise an inner floor, a plurality of inner walls, and an inner roof that collectively define an inner chamber. To establish a highly effective acoustic decoupling zone, an air pocket is defined between the outer enclosure and the inner enclosure, spacing the inner walls and the inner roof apart from the outer walls and the outer roof. In these configurations, fluid communication is established between the inner chamber, the air pocket, and the exterior of the outer enclosure to maintain continuous ventilation.

In any of the foregoing embodiments, the fluid communication may be established along an acoustically baffled pathway that is specifically configured to attenuate airborne noise. This pathway can be defined by an air inlet formed through at least one of the outer walls and a plurality of ceiling apertures formed through the inner roof of the inner enclosure, where the ceiling apertures are spatially offset from the air inlet. This offset arrangement forces incoming air and accompanying sound waves to travel along a tortuous, multi-directional path through the air pocket, causing sound waves to undergo multiple reflections and phase cancellations that drastically reduce noise levels before the air enters the inner chamber.

Furthermore, the feature of active air circulation may be incorporated into any of the described configurations. In some embodiments, an active air mover, such as a fan, is positioned within the air pocket adjacent to the inner roof. The active air mover can be configured to actively circulate air between the inner chamber, the air pocket, and the exterior of the outer enclosure, thereby resolving the conflict between the necessity of continuous ventilation and the requirement of acoustic isolation.

In any of the described embodiments, mechanical and vibrational decoupling of the inner enclosure may be achieved through a plurality of support structures. A plurality of inner feet may extend downward from the inner floor of the inner enclosure to rest on the outer floor of the outer enclosure, thereby supporting the inner enclosure in a floating manner. To minimize structure-borne vibration transmission, each of the inner feet may comprise a dome-shaped bottom surface. The dome-shaped geometry restricts the physical interface between the inner feet and the outer floor to a minimal tangent point-contact, which dramatically reduces the transmission of low-frequency ground vibrations, such as those from thunder or fireworks, into the inner floor. Similarly, the outer enclosure may be supported on an external surface by a plurality of outer feet, where each of the outer feet also comprises a dome-shaped bottom surface to minimize physical contact with the ground.

In any of the foregoing embodiments, a collar may be disposed between an outer surface of the inner enclosure and an inner surface of the outer enclosure. The collar may comprise a resilient foam material, such as an open-cell polyurethane foam, and can be configured to mechanically decouple the inner enclosure from the outer enclosure by absorbing compressive and shear forces. Additionally, the collar can be configured to provide an air buffer within the air pocket, effectively bifurcating the air pocket into a front portion and a back portion to direct airflow and assist in proper ventilation. In some aspects, the collar may optionally be configured to provide an interface or routing path for an external ground.

Furthermore, the feature of static electricity dissipation may be integrated into the system of any of the described embodiments to alleviate physiological distress in animals. A conductive grounding mat may be disposed on the inner floor of the inner chamber. To establish a safe grounding path, at least one of the inner feet may be electrically conductive and electrically coupled to the conductive grounding mat, allowing static charges accumulating on the animal's fur to be safely discharged to an external ground.

In any of the foregoing embodiments, the pet shelter may further comprise an acoustically sealed door assembly. A door opening may be formed through one of the outer walls, and a door may be pivotally coupled to the outer enclosure to move between an open position and a closed position. The door may comprise an inward-projecting sealing portion configured to extend through the door opening and interface directly with the inner enclosure when the door is closed, thereby forming an acoustic seal that prevents sound leakage into the air pocket.

In some aspects, the inner enclosure may be mechanically and acoustically decoupled from the outer enclosure by a plurality of decoupling elements working in synergy. The plurality of decoupling elements can comprise one or more of the air pocket spacing the inner walls and the inner roof apart from the outer walls and the outer roof, the plurality of inner feet supporting the inner floor relative to the outer floor, and a resilient collar disposed between an outer surface of the inner enclosure and an inner surface of the outer enclosure.

It will be appreciated that the embodiments of the present disclosure are merely exemplary and that various features and functions, or alternatives thereof, may be desirably combined into many other different systems or applications. Thusly, various alternatives, combinations, and omissions of specific components, as well as presently unforeseen or unanticipated modifications, variations, or improvements therein may be subsequently made by those skilled in the art, and are all intended to be encompassed by the appended claims.

### REFERENCE NUMERALS

1500 animal shelter
1510 outer wall
1520 bottom panel
1540 flange
1550 top panel
1560 top panel
1600 door
1610 hinge
1620 door panel
1630 latch
1640 door frame
1650 inner chamber
1660 vibration damping feet
1670 fan
1680 speaker
1690 gasket
1700 gasket
1710 baffle
1720 grounding mat
2000 animal shelter
2010 outer enclosure
2012 door
2014 outer roof
2016 outer feet
2018 outer floor member
2020 door opening
2022 outer wall member
2024 door wall member
2026 air apertures
2028 sealing portion of door
2030 inner enclosure
2031 inner chamber
2032 inner wall member
2034 inner roof member
2036 inner floor member
2038 inner feet
2039 dome-shaped bottom surface
2040 grounding mat
2042 collar
2046 ceiling apertures
2048 fan
2050 air pocket
2052 air pocket
2054 inlet apertures
2056 second ceiling apertures
2060 baseline curve
2062 baseline average line
2070 alternative design curve
2072 alternative average line
2080 new design curve
2082 new average line

What is claimed is:

1. An animal shelter comprising:
an outer enclosure comprising an outer floor, a plurality of outer walls, and an outer roof;
an inner enclosure nested within the outer enclosure, the inner enclosure comprising an inner floor, a plurality of inner walls, and an inner roof, the inner enclosure defining an inner chamber;
an air pocket defined between the outer enclosure and the inner enclosure, the inner enclosure being spaced apart from the outer enclosure by the air pocket;
a plurality of inner feet extending downward from the inner floor, the plurality of inner feet resting on the outer floor to support the inner enclosure relative to the outer enclosure;
an air inlet formed through at least one of the plurality of outer walls; and,
a plurality of ceiling apertures formed through the inner roof, the plurality of ceiling apertures being offset from the air inlet;
wherein the air inlet, the air pocket, and the plurality of ceiling apertures define an acoustically baffled pathway establishing fluid communication between an exterior of the outer enclosure and the inner chamber.

2. The animal shelter of claim 1, further comprising:
an active air mover positioned within the air pocket adjacent to the inner roof and configured to circulate air between the inner chamber, the air pocket, and the exterior of the outer enclosure.

3. The animal shelter of claim 1, further comprising a conductive grounding mat disposed on the inner floor.

4. The animal shelter of claim 1, further comprising a collar disposed between an outer surface of the inner enclosure and an inner surface of the outer enclosure, the collar configured to mechanically decouple the inner enclosure from the outer enclosure.

5. The animal shelter of claim 1, further comprising a plurality of outer feet extending downward from the outer floor to support the outer enclosure on an external surface, wherein each of the plurality of outer feet comprises a dome-shaped bottom surface.

6. The animal shelter of claim 1, wherein each of the plurality of inner feet comprises a dome-shaped bottom surface resting on the outer floor.

7. The animal shelter of claim 1, further comprising:
a door opening formed through one of the plurality of outer walls; and,
a door pivotally coupled to the outer enclosure and movable between an open position and a closed position to selectively close the door opening;
wherein the door comprises an inward-projecting sealing portion configured to interface with the inner enclosure to seal the inner chamber when the door is in the closed position.

8. The animal shelter of claim 1, wherein the inner enclosure is mechanically and acoustically decoupled from the outer enclosure by a plurality of decoupling elements.

9. The animal shelter of claim 8, wherein the plurality of decoupling elements comprises:
the air pocket spacing the inner walls and the inner roof apart from the outer walls and the outer roof;
the plurality of inner feet supporting the inner floor relative to the outer floor; and,
a collar disposed between an outer surface of the inner enclosure and an inner surface of the outer enclosure.

10. An animal shelter comprising:
an outer enclosure comprising an outer floor, a plurality of outer walls, and an outer roof;
an inner enclosure nested within the outer enclosure and mechanically decoupled from the outer enclosure, the inner enclosure comprising an inner floor, a plurality of inner walls, and an inner roof, the inner enclosure defining an inner chamber; and,
an air pocket defined between the outer enclosure and the inner enclosure, the inner enclosure being spaced apart from the outer enclosure by the air pocket;
wherein the inner chamber, the air pocket, and an exterior of the outer enclosure are in fluid communication.

11. The animal shelter of claim 10, further comprising:
a plurality of inner feet extending downward from the inner floor, the plurality of inner feet resting on the outer floor to support the inner enclosure relative to the outer enclosure.

12. The animal shelter of claim 11, wherein each of the plurality of inner feet comprises a dome-shaped bottom surface resting on the outer floor.

13. The animal shelter of claim 10, further comprising a collar disposed between an outer surface of the inner enclosure and an inner surface of the outer enclosure.

14. The animal shelter of claim 10, further comprising a plurality of outer feet extending downward from the outer floor to support the outer enclosure on an external surface, wherein each of the plurality of outer feet comprises a dome-shaped bottom surface.

15. The animal shelter of claim 10, further comprising a conductive grounding mat disposed on the inner floor.

16. The animal shelter of claim 10, further comprising an active air mover positioned within the air pocket and configured to circulate air between the inner chamber, the air pocket, and the exterior of the outer enclosure.

17. The animal shelter of claim 10, further comprising:
a door opening formed through one of the plurality of outer walls; and,
a door pivotally coupled to the outer enclosure and movable between an open position and a closed position to selectively close the door opening;
wherein the door comprises an inward-projecting sealing portion configured to interface with the inner enclosure to seal the inner chamber when the door is in the closed position.

18. The animal shelter of claim 10, wherein the inner enclosure is mechanically decoupled from the outer enclosure by one or more of:
the air pocket spacing the inner walls and the inner roof apart from the outer walls and the outer roof;
a plurality of inner feet extending downward from the inner floor and resting on the outer floor; and,
a collar disposed between an outer surface of the inner enclosure and an inner surface of the outer enclosure.
